(19) United States
(12) Patent Application Publication
(10) Pub. No.: US 2006/0293861 A1
(43) Pub. Date: Dec. 28, 2006

(54) Recursive base peak framing of mass spectrometry data

(76) Inventor: Manor Askenazi, Arlington, MA (US)

Correspondence Address: THERMO FINNIGAN LLC, 355 RIVER OAKS PARKWAY, SAN JOSE, CA, 95134, US

(21) Appl. No.: 11/408,351

(22) Filed: Apr. 21, 2006

Related U.S. Application Data
(60) Provisional application No. 60/686,743, filed on Jun. 1, 2005.
(60) Provisional application No. 60/719,940, filed on Sep. 9, 2005.

(51) Int. Cl. G06F 19/00

(52) U.S. Cl. 702/22

(57) ABSTRACT

A method for analyzing mass spectrometry data of biological and other samples for differential expression and data analysis is provided. The method employs a recursive base peak framing process for grouping spectral data points from sample sets together. Initially, a filtered set or all of the spectral data points in a raw data set are sorted by intensity, a global base peak, the peak of greatest intensity, is identified from the sample sets, and a frame is drawn around the global base peak. The remaining spectral data points are compared to the frame. Those that fit within the frame, and are likely to be associated with the global base peak, are associated with the frame in a database. An additional frame is established around the first spectral data point that does not fit within the defined frame. This spectral data point is a “local base peak,” a spectral data point of maximal intensity outside of the frame defined around the global base peak, and therefore not likely related to the global base peak. Subsequent spectral data points are evaluated to determine whether they fit within any previously established frame, and the remaining spectral data points are either consumed by an existing frame, or designated as a local base peak.

### CROSS-REFERENCE TO RELATED APPLICATIONS

This application claims priority to U.S. Provisional Patent Application 60/686,743 filed Jun. 1, 2005 and to U.S. Provisional Patent Application 60/719,940 filed Sep. 9, 2005.

### FIELD OF THE INVENTION

The present invention relates to methods for grouping data in sample sets of mass spectrometry data for statistical analysis.

### BACKGROUND

In mass spectrometry, chemical samples are ionized to generate spectra of mass to charge ratio (m/z) data for each sample. In recent years, mass spectrometry methods such as 2D-gel to mass spectrometry (2D-gel/MS) and liquid chromatography to mass spectrometry (LC/MS) have become prevalent in the study of biological samples, particularly to detect and characterize biomolecules such as proteins, peptides, oligosaccharides and oligonucleotides, and in proteomics, the high throughput study of large subsets of the proteins contained in an organism. In these applications, mass spectrometry data can be analyzed using bioinformatic methods to identify and quantify biomolecules, to analyze structural characteristics of biomolecules in general and proteins specifically, and to examine, for example, differences in biomolecular levels between control and treated biological samples, a process known as differential expression analysis.

While mass spectrometry has become a very important tool in biomolecular and proteomic analysis, the analysis of mass spectrometry data for biological samples is challenging due to the extreme size and complexity of the data sets produced by mass spectrometry in a typical study of biomolecules in general and proteomes in particular. A large number of structurally complex proteins are typically present in a single biological sample, for example, mass spectrometry analysis of proteomes produces a significant number of spectra, and the amount of data is increased even more when multiple samples are analyzed, as is necessary in differential expression profiling. The acquired data for a differential expression analysis, for example, can include thousands of different spectra stored in dozens or even hundreds of files. Pre-processing the data prior to analysis to categorize and reduce the amount of data to be analyzed is therefore an essential pre-condition for computational efficiency.

Presently, binning of data is one of the most frequently used preprocessing techniques for grouping related data and reducing the overall amount of data in mass spectrometry data analysis. Binning is a process in which the data in an experiment is reduced by rounding and grouping spectral data points together in a predetermined grid. Adjacent values are grouped together and either the largest intensity value of the combined data, or the sum of the intensities of the combined data is selected to represent the intensity of the binned data.

While prior art pre-processing methods such as binning are generally effective in reducing data for analysis, these techniques can be inaccurate. Because the process relies on rounding data into a predetermined grid, rounding errors can be induced. For example, when an identified molecule or peak falls between grid lines, it can be split across adjacent bins, thereby inducing an error, and reducing the accuracy of the analysis. There remains a need, therefore, for an improved method for processing mass spectrometry data in the context of differential expression analyses.

### BRIEF DESCRIPTION OF THE SEVERAL VIEWS OF THE DRAWINGS

FIG. 1 is a block diagram of a mass spectrometry data analysis process constructed in accordance with the present invention;

FIG. 2 is a flow chart illustrating the framing process of FIG. 1;

FIG. 3 is a data structure diagram illustrating the format of mass spectrometry data produced in the pre-processing step of FIG. 1;

FIG. 4 is a data structure diagram illustrating the storage of frame and associated peak detection data; and

FIG. 5 is a schematic illustrating the framing of spectral data points in accordance with the present invention.

### BRIEF SUMMARY OF THE INVENTION

The present invention provides a method for processing mass spectrometry data for statistical analysis using a recursive base peak framing process in which spectral data points are grouped together around “base peaks,” or spectral data points of locally maximal intensity in a mass to charge ratio, intensity, and time data space.

In this process, mass spectrometry data is acquired from samples of an experiment, and the resultant data is stored as spectral data points characterized by a mass to charge ratio, time, and intensity value, as well as the associated sample. The spectral data points from the experiment are sorted by intensity, and the spectral data point having the greatest intensity across all files in the experiment (the “global base peak”) is identified. A frame or window is established around the global base peak along at least a mass to charge ratio axis and preferably along mass to charge ratio and time axes, and the limits of the frame are selected to group together data that is likely related but from different sample sets within the experiment.

After the global base peak and associated frame are established, the remaining spectral data points in the set of experimental data are evaluated. The spectral data points that fit within the frame established around the global base peak are “consumed by” or associated with that frame. An additional frame is established around the most intense data point that does not fit within the defined frame. This data point is a “local base peak,” a spectral data point of maximal intensity outside of the frame defined around the global base peak, and therefore not likely related to the global base peak. Subsequent spectral data points are evaluated to determine whether they fit within any previously established frame, and the remaining spectral data points are either consumed by an existing frame, or designated as a local base peak. An additional frame is defined around each local base peak.

Upon completion of this process, related data is grouped together and can be analyzed to determine whether statistically significant differential expression exists between the spectral data points associated with the various experimental sample sets represented in the frame. Because the algorithm uses standard computational routines such as sorting and filtering which are heavily optimized on computer architectures, including the high-end PCs typically used in quantitative computation of differential expression, the implementation can be very fast.

In one aspect, the present invention provides a method for grouping spectral data points corresponding to two or more samples analyzed in a mass spectrometry experiment for statistical analysis. In the method, an intensity is evaluated for each spectral data point to identify a spectral data point having the greatest intensity in the experiment. The identified spectral data point is then framed in a frame of a selected width in a mass to charge ratio dimension. The remaining spectral data points are analyzed to identify a spectral data point having the greatest intensity that falls within the frame and corresponds to a sample other than the sample corresponding to the previously identified spectral data point and that falls within the frame. The spectral data points of greatest intensity are then grouped together in the frame for statistical analysis.

In another aspect of the invention, a local base peak is identified as the spectral data point having the greatest intensity outside of the frame. A second frame is defined around the local base peak, and the spectral data points corresponding to the two or more samples are evaluated to determine whether the spectral data points fall within the frame around the local base peak. The spectral data points that fall within the frame around the local base peak are grouped together. The step of identifying a local base peak as the spectral data point having the greatest intensity outside of the previously defined frames can be repeated, and frames defined around subsequently defined local base peaks.

In yet another aspect of the invention, the spectral data points can be filtered by intensity, or sorted by intensity.

In another aspect of the invention, a method for grouping spectral data points in a mass spectrometry sample set acquired by analyzing two or more samples by mass spectrometry for statistical analysis is provided. The spectral data points are sorted to identify a spectral data point with the greatest intensity in the mass spectrometry sample set, and a frame is defined around the spectral data point of greatest intensity along at least one of a time and a mass to charge ratio axis. The parameters associated with the frame are then stored in a frame data structure, and the remaining spectral data points are evaluated to identify the spectral data points that fall within the frame. The spectral data points that fall within the frame are analyzed to determine whether a statistically significant change exists between the spectral data points corresponding to the samples represented in the frame.

In another aspect of the invention, the spectral data points can be filtered to eliminate spectral data points below a threshold intensity from further analysis.

In still another aspect of the invention, a method for grouping spectral data points characterized by a mass to charge ratio, a time and an intensity from at least two samples analyzed by mass spectrometry for statistical analysis is provided. The method comprises the steps of sorting the spectral data points by intensity, establishing a frame characterized by a mass to charge ratio limit around the spectral data point having the greatest intensity and storing parameters identifying the frame in a data structure. After this frame is identified, for the remaining spectral data points, the mass to charge ratio associated with the spectral data point is compared to the limits of the frame in the data structure to determine if the spectral data point falls within the frame in the data structure, An additional frame is defined around the spectral data point if it does not fall within the frame in the data structure, and the parameters associated with the additional frame are also stored in the data structure. These steps are repeated for each spectral data point in the sample sets until all of the spectral data points are associated with a frame in the data structure.

These and other aspects of the invention will become apparent from the following description. In the description, reference is made to the accompanying drawings that form a part hereof, and in which there is shown a preferred embodiment of the invention. Such embodiment does not necessarily represent the full scope of the invention and reference is made therefore, to the claims herein for interpreting the scope of the invention.

### DETAILED DESCRIPTION OF THE PREFERRED EMBODIMENT

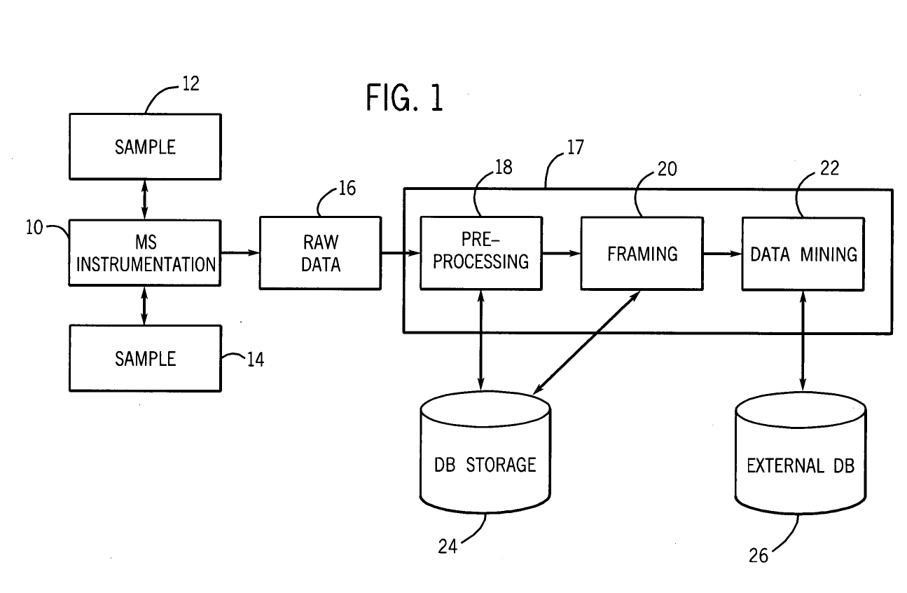

Referring now to the Figures and more particularly to FIG. 1, a block diagram generally illustrating a method of processing mass spectrometry data in accordance with the present invention is shown. The data for the analysis is acquired by performing one or more experiments on biological samples 12 and 14 with mass spectrometry instrumentation 10 to produce mass spectrometry spectra acquired for each sample in the experiment. The samples analyzed can include, for example, a pre-treatment control biological sample and a post-treatment biological sample, samples associated with different levels of disease, samples exposed to different levels of a stimulus, samples evaluated at different times to provide a time course of sample data, or other types of experimental data. Although two samples are shown here, the actual number of samples can be larger depending on the type of experiment performed. To limit complexity, the process will be described below with reference to two samples 12 and 14.

The mass spectrometry instrumentation 10 produces RAW or native files 16 of mass spectrometry data in a binary format, and these files are provided to a general purpose computer 17, which pre-processes the binary data to produce a sample data set for the experiment comprising sample data files associated with the corresponding samples 12 and 14. The general purpose computer 17 then applies a framing process 20, which groups related data from the sample data set around spectral data points of significant intensity (“base peaks,” which can be either “global base peaks” or “local base peaks” as discussed below), statistically analyzes the grouped data, and can further apply a data mining process 22 which can, for example, identify or analyze biomolecules in the samples. During processing, the general purpose computer 17 can be connected to a memory component such as external database storage 24 to provide storage for intermediate results and other data, and can also be connected to external databases 26 including spectral information libraries or genomic databases to identify biomolecules from the acquired data.

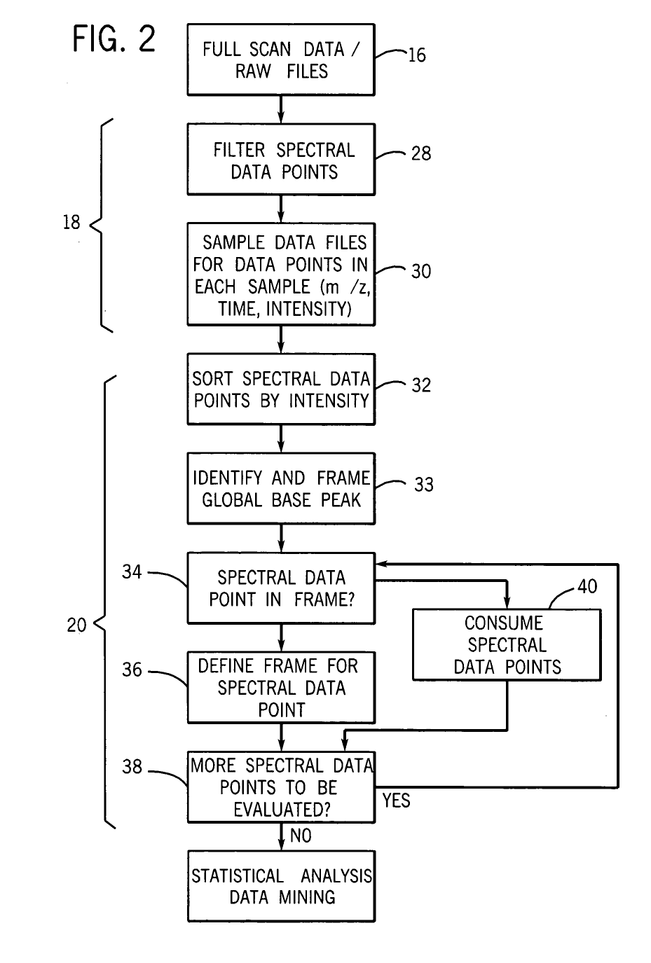

Referring now to FIG. 2, a detailed flow chart illustrating the pre-processing and frame identification process steps 18 and 20 is shown. During the pre-processing step 18, the general purpose computer 17 filters the mass spectrometry data received from the RAW files 16 (step 28). The filtering process can apply a threshold to limit the spectral data points examined to those having an intensity greater than the threshold value, or preferably, centroid the data to provide a series of spectral data points representing a single m/z and intensity estimate value for each peak identified in the acquired data. Alternatively, the mass spectrometry data could be normalized across all RAW files, or filtered by the signal to noise ratio of the spectral data point.

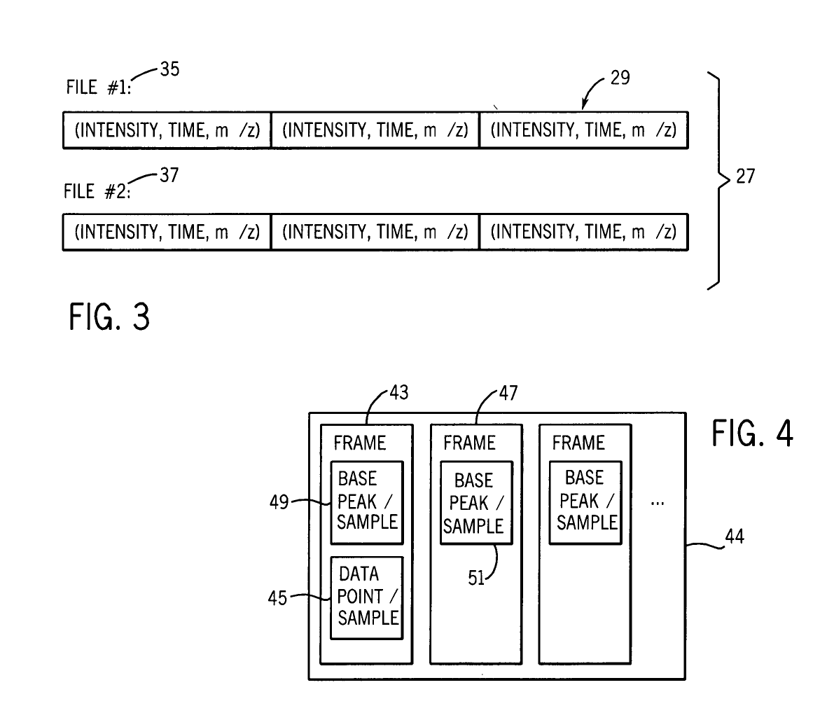

Referring now also to FIG. 3, after filtering, the sample data set 27 is segmented into sample data files 35 and 37 corresponding to the samples 12 and 14, respectively, each including spectral data points stored in a tuple format 29 (step 30). The tuple format includes data to characterize the spectral data points by a mass to charge ratio, time, and intensity parameter (m/z, time, intensity), as shown in FIG. 3. The time parameter can be a chromatographic time, or other time parameter. Furthermore, although the data is described and shown as comprising sample data files associated with each sample, it will be apparent that the spectral spectral data points could be stored as a 4-tuple characterized by a mass to charge ratio, time, intensity parameter, and an identifier for the corresponding sample.

Although, as described here, the sample data files are produced by mass spectrometry instrumentation, it will be apparent to those of skill in the art that sample data sets can also be retrieved from libraries and databases rather than produced specifically for experimental analysis. When converting the native files from a mass spectrometry experiment, software for converting the RAW or native files to sample data files is typically associated with the specific mass spectrometry instrumentation used in the experiment. One example of a program for converting RAW files to a text-based format which can be converted into sample data files is ReAdW, an open source program which is available for download from the Seattle Proteome Center of the NLHBI Proteomics Center at the Institute for Systems Biology. This program converts native files from a mass spectrometry instrumentation system to a mzXML format, which can be used to provide sample data files. Other programs for converting native of binary files to mzXML format for specific types of instrumentation are also available from the Seattle Proteome Center and will be known to those of skill in the art. Furthermore, rather than pre-processing and segmenting the data, RAW data files can also be used directly.

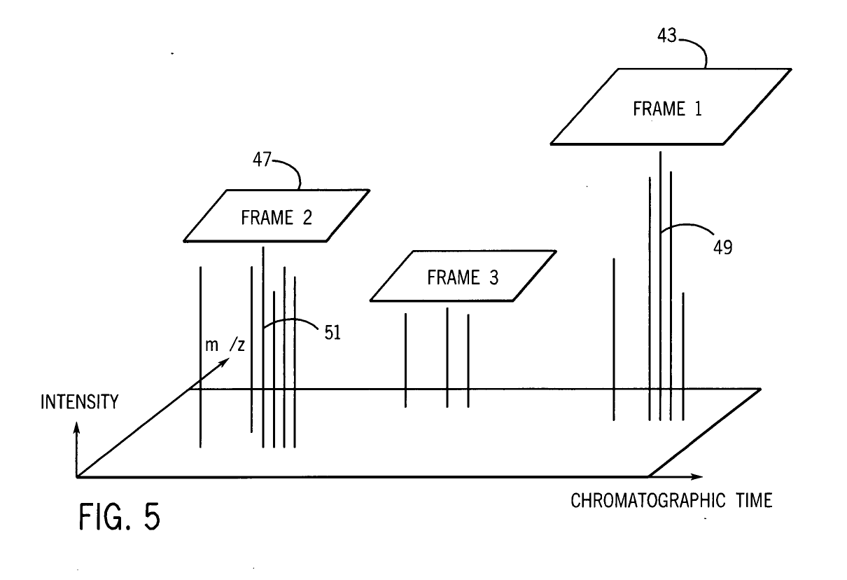

Referring still to FIG. 2, in step 32, the pre-processed data is fed to a frame identification process 20, which sorts the spectral data points in the sample data set for the experiment based on intensity to provide a sorted list extending from the spectral data point of greatest intensity to the spectral data point of lowest intensity. The frame identification process 20 then, in step 33, identifies the “global base peak” 49 (FIG. 5), the spectral data point having the greatest intensity in terms of absolute detection counts in the experiment. Referring now also to FIG. 5, a frame 43 is centered around the global base peak 49 in the mass to charge ratio and time plane, and establishes limits along the mass to charge ratio (m/z) axis, and when available and appropriate, also along the time axis, as shown. These limits are then used for comparing and grouping together spectral data points from all of the sample data files in the experiment which are likely to be related to the global base peak 49. The ranges or widths of the mass to charge ratio and time limits associated with the frame 43 can be defined using default values, or selected by a user through a user interface to general purpose computer 17 in any of a number of ways which will be well known in the art. After the global base peak 49 and frame 43 are established, the tuple data 29 associated with the global base peak 49 and frame width limits or ranges are stored in frame database 44 (FIG. 4).

After identifying the global base peak 49, the framing process 20 evaluates the remaining spectral data points in the set of experimental data, starting with the next most intense spectral data point in the sorted list. Referring again to FIGS. 2 and 4, if this spectral data point falls within the limits of the frame 43, the spectral data point is “consumed” by the associated frame in step 40. A consumed spectral data point 45 is catalogued in the frame database 44 with the corresponding frame and according to its sample set data file, which correlates the spectral data point with a sample 12 or 14 in the sample data set for the experiment. The frame database 44 therefore maintains a record of the spectral data points consumed for each sample in association with the corresponding frame.

If the evaluated spectral data point does not fit within the limits of the existing frame 43, the spectral data point is defined as a “local base peak” 51 (FIG. 5), a spectral data point of locally maximal intensity in the m/z and time plane, but unlikely to be related to the global base peak 49. In step 36, a new frame 47 is defined around this local base peak 51. Referring again to FIG. 4, after the new frame 47 is defined, data characterizing the local base peak 51 and frame 47 is added to the frame database 44. The process of evaluating spectral data points is then continued (step 38) until each individual spectral data point in the data stream is either identified as a local base peak and framed or consumed by another frame, and, as processing continues, local base peaks and frames are continually added to the database 44.

As shown schematically in FIG. 5, at the completion of the framing process 20, all of the spectral data points that fall within a defined frame are associated or grouped together in the m/z and time plane. As shown here, the global base peak 49 is provided in frame 43, and is grouped with other spectral data points from the sample data files associated with samples 12 and 14 that fall within the frame 43. Local base peak 51 is similarly provided in frame 47, and is grouped with associated spectral data points.

This resultant frame data can be used to test for a statistically significant change between the samples 12 and 14 in the experiment, and the results of this analysis can be used to determine whether other data mining or analysis procedures are appropriate for a given frame.

In order to evaluate the frame data, various statistical tests can be performed within the frames to determine the statistical significance of differences between spectral data points from the different sample sets represented in the frame. These tests can be selected based on the experimental design (A vs. B, time course, etc.) and type of data being analyzed. In a two-group randomized controlled study, a t-test can be performed on peak intensities to test for a difference in mean peak intensities. In paired tests, a paired t-test could also be used. For experiments that include larger data sets of three or more samples, statistical analyses such as Analysis of Variance (ANOVA) and regression analyses are appropriate and could be used.

For time course studies, such as a single-group longitudinal study, a correlation test, such as a Pearson's product moment correlation test, can alternatively be used to test for significant correlation between peak intensity and experimental time. Software for providing a Pearson's product moment correlation test includes the R language that is described, for example, in An R and S-Plus Companion to Applied Regression, John Fox Sage Publications, Thousand Oaks, Calif., USA, 2002; and Data Analysis and Graphics Using R., John Maindonald and John Braun, Cambridge University Press, Cambridge, 2003.

Once a statistical analysis is completed, a p-value indicating the likelihood that the frame includes significant data can be calculated, and a report generated containing, for example, data identifying the frame, its base peak (either global or local) coordinates (time, m/z, intensity) as well as the associated test p-value. The test can also be sorted or thresholded and sorted by p-value, to provide the frame most likely to include a statistically significant result first. Various other methods of providing a report will be apparent to those of skill in the art.

Once significant frames are identified, an identification analysis, such as a SEQUEST analysis, or a comparison to library data can be performed to analyze the biomolecules in the sample. These analyses can be performed either internally in the general purpose computer 17, or using data accessed through external databases 26 such as GenBank. Other data repositories, and particularly libraries of spectral information can also be used. These libraries, for example, are available through the National Institute of Standards and Technologies, which provides the NIST 05 spectral library.

Although specific embodiments have been shown and described, it will be apparent that a number of variations could be made within the scope of the invention. For example, although the method has been described above specifically with reference to biological samples and biomolecules, the methods of the present invention could be applied to other types of mass spectrometry data and in other applications where data reduction and grouping is desirable.

Additionally, although the method is described above as a loop in which all of the data in a mass spectrometry data set is examined and framed, it will be apparent that the analysis could be performed on a reduced set of data. For example, in some applications a single frame could be defined around the global base peak, and the remaining data evaluated to determine only if the data falls within the defined frame. Alternatively, a predetermined number of frames could be established, or a minimum intensity level could be established for local base peaks, and the remaining data ignored. As another alternative, it is also possible to limit the number of spectral data points associated with a frame. Here, for example, after a base peak and at least one spectral data point from another sample set are grouped together, evaluating data for inclusion in the frame can be stopped. Various other methods of reducing the data for analysis will be apparent to those of skill in the art.

Furthermore, although filtering based on a threshold intensity level is described, in alternate embodiments, other filtering measures could also be used. For example, a detection threshold could be established as a function of mass to charge ratio to account for known shifts in baseline intensity. Similar results could be achieved by applying background subtraction to account for known shifts in baseline intensity. Additionally, although filtering of the peak data is shown in a specific order above, it will be apparent that filtering could be performed at a number of different steps in the process described. Furthermore, although a filtered data stream is preferred, all of the spectral data points could be extracted from the input RAW data files and processed, without including a filtering step. Centroided data, as described above, provides another method of filtering and reducing the amount of data for analysis.

Furthermore, although the method is shown and described with reference to frames defined in terms of both mass to charge ratio and time, frames can be established based on a mass to charge ratio limit alone, or in terms of time alone.

In addition, although the method of the present invention is described above as including a step wherein mass spectrometry instrumentation is used to acquire the sample set data files, it is also possible to acquire sample data for analysis from libraries or databases, and to evaluate this data using the method described above.

It will be apparent to those of ordinary skill in the art, therefore, that many variations could also be provided. It should be understood therefore that the methods and apparatuses described above are only exemplary and do not limit the scope of the invention, and that various modifications could be made by those skilled in the art that would fall under the scope of the invention. To apprise the public of the scope of this invention, the following claims are made:

1. A method for grouping spectral data points corresponding to two or more samples analyzed in a mass spectrometry experiment for statistical analysis, the method comprising the following steps:
(a) evaluating an intensity of each spectral data point to identify a spectral data point having the greatest intensity in the experiment;
(b) framing the spectral data point having the greatest intensity in a frame of a selected width in a mass to charge ratio dimension;
(c) evaluating the remaining spectral data points to identify a spectral data point having the greatest intensity that falls within the frame and corresponds to a sample other than the sample corresponding to the spectral data point identified in step (a); and
(d) grouping the spectral data points identified in steps (a) and (c) together for statistical analysis.

2. The method as recited in claim 1, wherein step (c) further comprises the step of identifying all of the spectral data points that fall within the frame.

3. The method as recited in claim 1, further comprising the steps of identifying a local base peak as the spectral data point having the greatest intensity outside of the frame, defining a frame around the local base peak, and evaluating the spectral data points corresponding to the two or more samples to determine whether the spectral data points fall within the frame around the local base peak, and grouping the spectral data points that fall within the frame around the local base peak together.

4. The method as recited in claim 3, further comprising the step of repeatedly identifying a local base peak as the spectral data point having the greatest intensity outside of the previously defined frames, defining a frame around the additional local base peak, and evaluating the spectral data points to determine whether the spectral data points fall within the frame around the local base peak until all of the spectral data points are associated with at least one of the defined frames.

5. The method as recited in claim 1, wherein the two or more samples include a pre-treatment biological control sample and a post-treatment biological sample.

6. The method as recited in claim 1, wherein step (a) further comprises the step of filtering the spectral data points by intensity.

7. The method as recited in claim 1, wherein step (a) further comprising the step of sorting the spectral data points by intensity.

8. The method as recited in claim 1, wherein step (c) comprises the step of maintaining a database of the spectral data points associated with the frame.

9. The method as recited in claim 1, further comprising the step of performing a statistical test on the spectral data points in the frame to calculate a statistical significance of differential expression between the spectral data points from one of the two or more samples and the spectral data points from another of the two or more samples.

10. The method as recited in claim 1, wherein the spectral data points are characterized by a mass to charge ratio, time, and intensity.

11. The method as recited in claim 1, wherein the spectral data points are centroided.

12. A method for grouping spectral data points in a mass spectrometry sample set acquired by analyzing two or more samples by mass spectrometry for statistical analysis, wherein the spectral data points are characterized by an intensity, a time, a mass to charge ratio, and a corresponding sample, the method comprising:
(a) sorting the spectral data points to identify a spectral data point with the greatest intensity in the mass spectrometry sample set;
(b) defining a frame around the spectral data point of greatest intensity in at least one of a time and a mass to charge ratio dimension and storing the parameters associated with the frame in a frame data structure;
(c) evaluating the remaining spectral data points to identify the spectral data points that fall within the frame; and
(d) analyzing the spectral data points within the frame to determine whether a statistically significant change exists between the spectral data points corresponding to the different samples represented in the frame.

13. The method as recited in claim 12, further comprising the step of defining a second frame around the spectral data point having the highest intensity that does not fall within the frame, and repeating step (c) to determine whether the remaining spectral data points in the mass spectrometry data set fall within the second frame.

14. The method as recited in claim 12, step (a) further comprises the step of filtering the spectral data points to eliminate spectral data points below a threshold intensity from further analysis.

15. The method as recited in claim 12, wherein step (b) comprises sorting each of the spectral data points by intensity to produce a sorted list of spectral data points extending from the spectral data point of greatest intensity to the spectral data point of least intensity.

16. A method for grouping spectral data points characterized by a mass to charge ratio, a time and an intensity from at least two samples analyzed by mass spectrometry for statistical analysis, the method comprising the steps of:
(a) sorting the spectral data points by intensity;
(b) establishing a frame characterized by a mass to charge ratio limit around the spectral data point having the greatest intensity and storing parameters identifying the frame in a data structure; and
(c) for the remaining spectral data points:
(i) comparing the mass to charge ratio associated with the spectral data point to the limits of the frame in the data structure to determine if the spectral data point falls within the frame in the data structure;
(ii) defining an additional frame around the spectral data point if it does not fall within the frame in the data structure, and storing the additional frame in the data structure; and
(iii) repeating steps (i) and (ii) for each spectral data point in the sample sets until all of the spectral data points are associated with a frame in the data structure.

17. The method as recited in claim 16, wherein step (a) further comprises the step of filtering the spectral data points.

18. The method as recited in claim 17, wherein the step of filtering the spectral data points comprises filtering by signal to noise ratio.

19. The method as recited in claim 16, further comprising the step of analyzing the spectral data points in each of the frames to identify frames in which a statistically significant difference exists between the spectral data points from the at least two samples.

20. The method as recited in claim 16, further comprising the step of analyzing the frames identified as having statistical significance by comparison to a mass spectral database.

21. The method as recited in claim 17, further comprising the step of analyzing the frames identified as having a statistical significance using SEQUEST.

22. The method as recited in claim 16, further comprising the step of limiting a number of frames identified to a predetermined number.
